(19) United States
(12) Patent Application Publication
(10) Pub. No.: US 2002/0037385 A1
(43) Pub. Date: Mar. 28, 2002

(54) Device for the diffusion of a volatile product and preparation process

(76) Inventors: Cyrille Pignot, Meudon (FR); Laurent Artaud, Joinville Le Pont (FR)

Correspondence Address: Stephen B. Maebius, FOLEY & LARDNER, 3000 K Street, N.W., Suite 500, Washington, DC, 20007-5109, US

(21) Appl. No.: 09/870,940

(22) Filed: Jun. 1, 2001

Related U.S. Application Data
(60) Provisional application No. 60/209,990, filed on Jun. 8, 2000.

(51) Int. Cl. B32B 7/06

(52) U.S. Cl. 428/40.1; 428/523

(57) ABSTRACT

The present invention relates to a device for the diffusion of a volatile product into the atmosphere which is intended in particular to be applied to the skin and which comprises a matrix intended to diffuse the volatile product, said matrix being based on an ethylene/vinyl acetate (EVA) copolymer, wherein said copolymer represents a melt index of between 0.5 and 20 g/10 min, measured according to Standard ASTM D 1238, and a melting point of between 65 and 90° C.

This device can be obtained by extrusion of an EVA powder impregnated with volatile product.

The present invention relates to a device for the diffusion of a volatile product into the atmosphere and to a process for its manufacture.

The device for the diffusion of a volatile product of the invention is more particularly intended to be applied to the skin.

Devices (or patches) for the diffusion of a volatile product have to make possible rapid release of the product for 8 to 24 hours, be practical to use (in particular thin, unobtrusive and translucent) and make possible diffusion toward the atmosphere in the immediate vicinity of the skin while avoiding direct contact of the product with the skin.

Application FR 2,745,720 discloses a device for the controlled diffusion of a volatile product into the atmosphere comprising a layer of a hydrophobic polymeric film of ethylene/vinyl acetate (EVA) type comprising 15 to 50% of hydrophilic inclusions, in which layer a volatile product is trapped. 90% of the charge of volatile product enclosed in the polymeric film is released into the atmosphere between 8 and 24 hours.

In the context of the present invention, the device for the diffusion of a volatile product also comprises a polymeric film charged with volatile product but the polymer used is different. This is because it has been discovered, in the context of the present invention, that, in order to obtain a diffusion device which exhibits good hold on the skin and which is as thin as possible without breaking during the manufacturing process, it is necessary to choose a polymeric film possessing certain characteristics. The EVA polymer comprising 15 to 50% of hydrophilic inclusions disclosed in FR 2,745,720 does not meet these criteria.

In addition, it has been discovered that the use of an EVA copolymer not comprising hydrophilic inclusions makes possible release of the product for at least 8 hours.

By virtue of the choice of the EVA copolymer described above, the device for the diffusion of a volatile product according to the invention can comprise pulverulent products, for example polyacrylate microspheres, in order to increase the loading capacity of the matrix or in order to slow down the rate of diffusion of the volatile products. Thus, the thickness of the matrix is greatly reduced and its hold on the skin is improved.

A subject-matter of the present invention is a device for the diffusion of a volatile product into the atmosphere which is intended in particular to be applied to the skin and which comprises a matrix intended to diffuse the volatile product, said matrix being based on an ethylene/vinyl acetate (EVA) copolymer, wherein said copolymer represents a melt index of between 0.5 and 20 g/10 min, measured according to Standard ASTM D 1238, and a melting point of between 65 and 90° C.

The melt index is preferably between 0.5 and 10 g/10 min. Furthermore, the EVA copolymer advantageously exhibits a breaking stress of 2000 N/cm².

EVAs with excessively high melt indices are too fluid and too sticky, so much so that the material cannot be correctly worked in the form of a film.

The EVA copolymer is chosen, for example, from Icorene® MP 00623-18, MP 00119-35, MP 02020-35 and their blends.

Icorene® MP 00119-35 is characterized by a melt index of 0.65 g/10 min and a melting point of 83° C. Icorene® MP 00623-18 is characterized by a melt index of 5.5 g/10 min and a Vicat point of 63° C. Icorene® MP 02020-35 is characterized by a melt index of 20 g/10 min and a melting point of 83° C.

The Vicat point, measured according to Standard ASTM D 1525, is lower than the melting point by 10 to 20° C.

The melting temperatures of the EVAs chosen lie between 65 and 90° C., which allows extrusion to be carried out at temperatures which are sufficiently low to considerably restrict the losses and the decomposition of the volatile product during the extrusion.

The mechanical properties of EVA confer good elasticity on the matrix. This property makes it possible on the one hand, to easily stretch the film and, on the other hand, to obtain thinner matrices (100 μm and less).

The matrix is advantageously a translucent film with a thickness of between 150 and 300 μm comprising 0.5 to 30% of volatile product, preferably 10 to 20%, for example 20%, with respect to the weight of the matrix.

According to a preferred embodiment, the device for the diffusion of a volatile product according to the invention comprises five layers:

a) the matrix based on the EVA copolymer described above comprising the volatile product,

b) an impermeable film which makes it possible to prevent the diffusion of the volatile product toward the skin,

c) an adhesive which makes it possible to attach said matrix to said impermeable film,

d) an adhesive which makes it possible to maintain the device on the skin,

e) a peelable protective layer to be removed before application to the skin.

The elasticity of the EVA used in the context of the invention furthermore makes it possible to absorb the deformation of the matrix when the latter loses its charge of volatile product and consequently to obtain better hold of the patch on the skin.

The thickness of the matrix and the charge of volatile product are jointly optimized, so as to restrict the phenomena of delamination and to obtain good adhesion of the diffusion device.

The delaminations will increase in significance as the matrix becomes thicker and as the charge of volatile product increases. Furthermore, the lower the charge of volatile product, the better the adhesion. Consequently, in order to increase the unit charge of volatile product per diffusion device, it will be preferable to decrease the thickness of the film and to increase the concentration of volatile product.

The adhesive (c) which makes it possible to attach the matrix to the impermeable film is composed, for example, of a styrene-isoprene elastomer (Kraton® D-1161N/Shell Chemicals) and of a polyterpene resin (Dercolyte® A115/DRT) in combination with an antioxidant (Irganox® 1010).

The impermeable film (b) is advantageously a coextruded OPP film with a thickness of 35 μm or else a 23 μm polyester.

The adhesive which makes it possible to maintain the patch on the skin (d) can, depending on the situation, be an acrylic medical adhesive (e.g. Duro-tak® 387-2054, National Starch) or a rubber medical adhesive (e.g. Morstik 153 from Morton).

Finally, the peelable protective layer (e) to be removed can be a 75 μm polyester film coated with silicone on one face (4P Embalflex) or a silicone-coated film made of polypropylene or of paper.

In this embodiment, the diffusion device has a thickness of the order of 200 to 500 μm, preferably 350 μm. The unit content of volatile product is between 8 and 35 mg.

The volatile product is chosen from insect repellents of natural or synthetic origin, essential oils, fragrances, scenting compositions, terpene derivatives which can be inhaled, such as menthol, camphor or eucalyptol, and their mixtures.

The volatile product is an essential oil chosen from essential oils of citronella, of geranium, of cedar wood, of lavender, of eucalyptus, of lemon grass, of yarrow, of peppermint, of cloves, of thuya or of neem and their mixtures.

Another subject-matter of the present invention is the manufacture of the device for the diffusion of a volatile product. According to the manufacturing process of the invention, the matrix is obtained by the extrusion of an EVA powder impregnated with the volatile product.

The main stages of the manufacturing process are as follows:

Impregnating the EVA powder with the volatile product, preferably for 12 to 24 h.

Extruding the matrix (a): the EVA powder impregnated with volatile product is kneaded in a Buss kneader and then extruded in an extruder equipped with a flat die, and the film thus formed is calendered and then wound up. The range of temperatures used varies from 50° to 110° C. as a function of the heating zones, preferably 70° C.

Coating the adhesive (d) onto the impermeable film (b).

Coating the adhesive (c) onto the other face of the impermeable film (b).

Laminating the peelable protective layer (e) onto the adhesive (d).

Stamping and packaging the patches.

According to an alternative form, the EVA powder and the volatile product are introduced simultaneously into the Buss kneader via respectively the metering hopper and an injection system placed downstream of the hopper. In this case, the volatile product is introduced directly into the molten copolymer and the preliminary impregnation stage is thus avoided.

The EVA is advantageously a powder with a grain size not exceeding 1000 μm, in order to provide a maximum contact surface area and thus better absorption of the volatile products by the polymer.

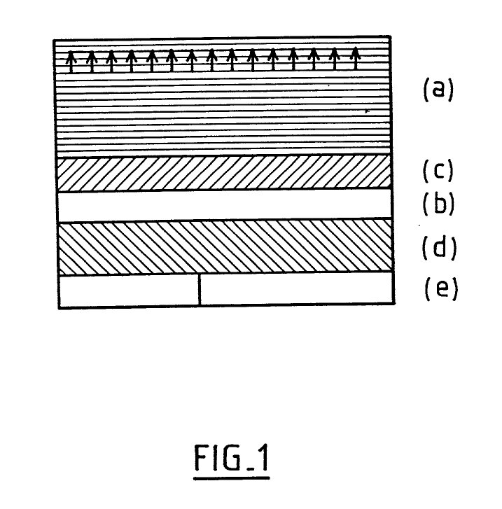

FIG. 1 represents the structure of a diffusion device according to the invention comprising 5 layers:

a) matrix diffusing the volatile product,

c) adhesive for attaching the matrix,

b) impermeable film,

d) adhesive for maintaining on the skin,

e) peelable protective layer.

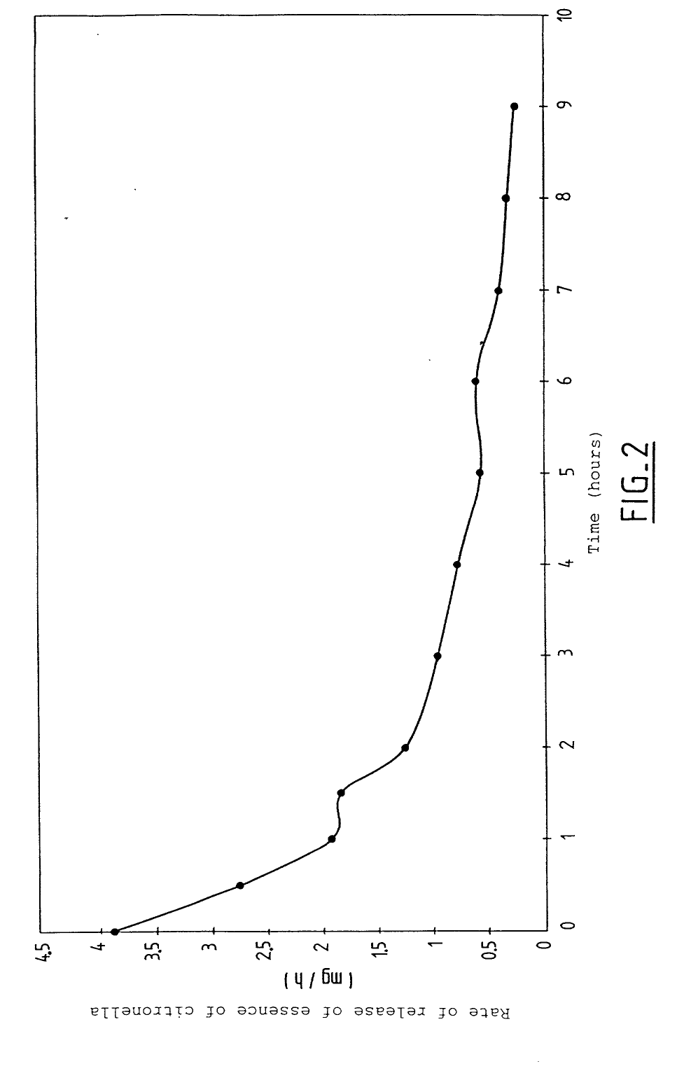

FIG. 2 represents the rate of release of essence of citronella from the patches of Example 1.

### EXAMPLE 1

An anti-mosquito patch which diffuses citronella is prepared composed of 5 layers: a matrix comprising the essence of citronella, an adhesive for attaching the matrix, an impermeable film, an adhesive for maintaining on the skin and a peelable protective layer.

Formula of the Matrix

| Chemical or INCI name | Amount, % by weight |
|---|---|
| Ethylene/vinyl acetate (Icorene ® | 80 |
| MP 02020-35) | |
| Essence of citronella (Laserson) | 20 |

Icorene® MP 02020-35 exhibits the following characteristics:

melt index: 20 g/10 min

percentage of vinyl acetate monomer: 20% by weight

relative density: 0.940 g/cm³

melting point: 83° C.

particle size: 500 μm

Formula of the Adhesive for Attaching the Matrix

| Chemical or INCI name | Amount, % by weight |
|---|---|
| Isoprene-styrene copolymer | 39.8 |
| Polyterpene resin on alpha- | 59.8 |
| pinene | |
| Pentaerythrityl tetrakis [3- | 0.4 |
| (3,5-di-tert-butyl-4- | |
| hydroxyphenyl)propionate] | |

Formula of the Adhesive for Maintaining on the Skin

The adhesive for maintaining on the skin is an acrylic copolymer (Duro-tak®)

Formula of the Impermeable Film

The impermeable film situated between the skin adhesive and the adhesive for attaching the matrix is made of oriented polypropylene (35 μm OPP, Brodart).

Formula of the Peelable Protective Layer

The peelable protective layer is a poly(ethylene glycol terephthalate) film coated with silicone at the surface (4P EmbalFlex).

1. The Manufacture of the Matrix by Extrusion

1.4 kg of essence of citronella (Laserson) are incorporated in 5.6 kg of Icorene MP 02020-35 and the mixture is kneaded until a wet homogeneous powder impregnated with essence of citronella is obtained. The preparation is transferred into a hermetically closed vessel of a rotary mixer, which is allowed to rotate for 24 hours.

The pulverulent blend is extruded at 75° C. in order to obtain a polymeric film with a thickness of 150 μm and a machine width of 12 cm. The powder blend is introduced into a Buss mixer-kneader via a feed hopper and the molten material is kneaded and then expelled into an extruder, in which the material is pressurized by virtue of an Archimedean screw. At the other end of the extruder, the material passes into a flat die to give a film, which is subsequently calendered and then wound up on a drum.

Under these conditions, the content of essence of citronella in the matrix after the extrusion is 17.3%. The loss of volatile product during the extrusion is 13.5%.

2. Coating the Adhesive for Maintaining on the Skin

The adhesive Duro-tak® 387-2054, dissolved in a 19/2/12/19 ethyl acetate/toluene/heptane/propan-2-ol mixture at a concentration of 47.5%, is deposited at the rate of 40 g/m² on silicone-coated paper over a machine width of 250 mm by virtue of a blade coater. The deposit of adhesive is introduced into a dryer in order to evaporate the solvents and then complexed with 35 μm OPP.

The complex 1 obtained (silicone-coated paper/skin adhesive/35 μm OPP) is conditioned on a drum and cut up lengthwise to a machine width of 125 mm.

3. Coating the Adhesive for Attaching the Matrix

3.1 Formula of the adhesive
Formula of the adhesive for attaching the matrix

| | Supplier | Amount, kg |
|---|---|---|
| Kraton ® D1161NS | Shell | 1 |
| | Chemicals/Lambert | |
| | Rivière | |
| Dercolyte ® A 115 | DRT/ITIF | 1.5 |
| Irganox ® 1010 | Ciba-Geigy/ITIF | 0.01 |

The solvent used is a 67/33 m/m petroleum ether/methyl ketone mixture.

The solids content represents 50% of the formula of the adhesive.

3.2 Coating the Adhesive

The adhesive is coated at the rate of 30 g/m² on the 35 μm OPP face of the complex 1. The deposit of adhesive is introduced into a dryer in order to evaporate the solvents and is then complexed with the polymeric matrix comprising the essence of citronella.

The complex 2 obtained (silicone-coated paper/skin adhesive/35 μm OPP/matrix adhesive/matrix) is conditioned on a drum and then placed in a sealed container while awaiting lamination.

4. Laminating the Peelable Protective Layer

4.1 Slitting the Peelable Protective Layer

Before being laminated with the complex, the peelable protective layer is subjected to two operations:

a lengthwise cutting, which constitutes the future slit of the peelable protective layer of the patches,

a complexing of the non-silicone-coated side with a substrate made of tacky polyethylene LDPE (Novacel), in order to provide for the transportation of the patches after stamping. The complex 3 formed (slit 75 μm silcone-coated polyester/LDPE transporter) is again cut to a machine width of 125 mm.

4.2 Complexing of the Complex 2 with the Peelable Protective Layer

The complex 2 is freed from the silicone-coated paper and then complexed with the silicone-coated face of the 75 μm polyester lined with the LDPE adhesive protective layer of the complex 3.

The complex 4 (matrix/matrix adhesive/35 μm OPP/skin adhesive/complex 3) is conditioned on a drum and placed in a sealed container until stamping.

5. Stamping

The complex 4 is introduced into the stamping machine with the matrix facing upward. The complex is cut out in a horizontal position into circles with a diameter of 3 cm and then removed. At the other end of the machine, the cut-out patches are placed on the LDPE transporter. The drums are placed in a sealed container while awaiting packaging.

6. Packaging

The patches are placed in individual bags of appropriate size in a paper/PE/alu/PE complex.

7. Control on the Patches

1) Control of the unit charge per patch: 18 mg

2) Test of hold on the skin: the patches are applied to the forearms of 7 subjects. The adhesion and the possible delaminations are observed for 8 hours. The results are presented in the following table:

| | | |
|---|---|---|
| % patches adhering well at | 2 h | 100% |
| | 5 h | 92% |
| | 8 h | 75% |
| % patches without delamination at | 2 h | 100% |
| | 5 h | 100% |
| | 8 h | 100% |

3) Release kinetics of essence of citronella in vitro at 32° C.

The patches are placed on a heating plate thermostatically controlled at 32° C. and the loss of essence of citronella is measured for 10 h. Over 10 h, 58.3% of the initial charge of citronella is released. The release profile for essence of citronella obtained under these conditions is presented in FIG. 1.

1. A device for the diffusion of a volatile product into the atmosphere which is intended in particular to be applied to the skin and which comprises a matrix intended to diffuse the volatile product, said matrix being based on an ethylene/vinyl acetate (EVA) copolymer, wherein said copolymer represents a melt index of between 0.5 and 20 g/10 min, measured according to Standard ASTM D 1238, and a melting point of between 65 and 90° C.

2. The diffusion device as claimed in claim 1, wherein the melt index is between 0.5 and 10 g/10 min.

3. The device as claimed in claims 1 and 2, wherein said EVA copolymer exhibits a breaking stress of 2000 N/cm².

4. The device as claimed in one of the preceding claims, wherein the matrix has a thickness of between 150 μm and 300 μm.

5. The device as claimed in one of the preceding claims, wherein the volatile product represents between 0.5 and 30% of the weight of the matrix, preferably between 10 and 20% by weight of the matrix.

6. The device as claimed in one of the preceding claims, which comprises five layers:
a) the matrix based on the EVA copolymer comprising the volatile product,
b) an impermeable film which makes it possible to prevent the diffusion of the volatile product toward the skin,
c) an adhesive which makes it possible to attach said matrix to said impermeable film,
d) an adhesive which makes it possible to maintain the device on the skin,
e) a peelable protective layer to be removed before application to the skin.

7. The device as claimed in one of the preceding claims, wherein its thickness is between 200 and 500 μm, preferably of the order of 350 μm.

8. The device as claimed in claim 6 or 7, wherein the adhesive (c) which makes it possible to attach the matrix to the impermeable film is composed of an isoprene-styrene elastomer, of a polyterpene resin and of an antioxidizing agent.

9. The device as claimed in one of claims 6 to 8, wherein the impermeable film (b) is a polyester or OPP film and the peelable protective layer (e) is a silicone-coated film made of polyester, of polypropylene or of paper.

10. The device as claimed in one of the preceding claims, wherein the volatile product is chosen from insect repellents of natural or synthetic origin, essential oils, fragrances, scenting compositions, terpene derivatives which can be inhaled, such as menthol or camphor, and their mixtures.

11. The device as claimed in one of the preceding claims, wherein the volatile product is an essential oil chosen from essential oils of citronella, of geranium, of cedar wood, of lavender, of eucalyptus, of lemon grass, of yarrow, of peppermint, of cloves, of thuya or of neem and their mixtures.

12. The device as claimed in one of the preceding claims, wherein the content of volatile product is between 8 and 35 mg per device.

13. A process for the preparation of the device as claimed in one of the preceding claims, wherein the matrix is obtained by the extrusion of an EVA powder impregnated with the volatile product.

14. The process for the preparation of the device as claimed in claim 12 or 13, wherein the volatile product is introduced into the molten EVA before extruding the copolymer.
